(19) United States
(12) Patent Application Publication
(10) Pub. No.: US 2007/0278263 A1
(43) Pub. Date: Dec. 6, 2007

(54) Emergency egress carrier for child or pet

(76) Inventors: David F. Zak, Buffalo, MN (US); Jack W. Smith, Minnetonka, MN (US); Curtis D. Kinghorn, Lino Lakes, MN (US)

Correspondence Address: Curtis D. Kinghorn;Sirius Strategic, LLC, 6769 W. Shadow Lake Dr., Lino Lakes, MN, 55014, US

(21) Appl. No.: 11/447,373

(22) Filed: Jun. 6, 2006

(51) Int. Cl. A61G 1/00

(52) U.S. Cl. 224/160

(57) ABSTRACT

The present invention is a device to be used during an emergency egress situation to enable a user to safely and effectively carry a child or pet during the emergency egress while at the same time allowing the user the full use of his or her arms during the egress. The device includes a pouch that is secured to the user's chest by means of straps that pass from the pouch over the user's shoulders, around the user's back and which are then secured to the pouch. The straps are easily adjustable to allow the invention to be put on the user and then rapidly secured to the user. The pouch is dimensioned to receive and securely hold a child or pet. The pouch also includes straps or a closure top that secures the child or pet within the pouch.

### BACKGROUND OF THE INVENTION

1. Field of the Invention

The present invention is directed to devices and methods for enabling emergency egress or making egress easier from structures such as buildings and more particularly relates to a device and method for allowing a user to safely and effectively carry a child or pet during the emergency egress while at the same time allowing the user the full use of his or her arms during the egress.

2. Description of Related Art

Emergency egress is defined as the travel from a point of actual or perceived danger to a point of safety. The term emergency egress is particularly used in connection with egress from buildings or transportation devices during emergencies such as fires or other calamites. Fires in buildings, particularly commercial buildings such as high rise office buildings, apartments or hotels, and the concomitant need to safely escape from such buildings in an emergency have always been a source of concern. Leaving a building in an emergency situation is particularly difficult when one must take their child or pet with them. Although clearly not all building fires are in high rise buildings, reports from the US Fire Administration (Residential Fires and Child Casualties) show that about 1250 children under the age of five were injured or killed in residential fires in 2002. It is possible that several of these injuries or deaths were related to the difficulty in making an emergency egress with the child.

Many different ways have been developed to enable safe, rapid and effective emergency egress from buildings. Perhaps the most common method of aiding emergency egress from a building is to provide fire escapes, typically in the form of ladders attached to the outside of buildings. There are also many examples of ladders used to aid in emergency egress. Examples of ladders deployed down the side of a building and used for emergency egress are disclosed in U.S. Pat. No. 3,999,627 issued to Hiromitsu Naka on Dec. 28, 1976 entitled “Emergency Escape;” U.S. Pat. No. 4,127,184 issued on Nov. 28, 1978 to Robert W. Strohmeyer entitled “Combination Flower Box and Fire Escape;” U.S. Pat. No. 4,211,306 issued to Robert Brenner on Jul. 8, 1980 entitled “Emergency Building Escape Ladder;” U.S. Pat. No. 4,236,601 issued to Hiromitsu Naka on Dec. 2, 1980 entitled “Turning Type Emergency Escape;” U.S. Pat. No. 4,240,521 issued to Hiromitsu Naka on Dec. 23, 1980 entitled “Drawer Type Emergency Escape;” U.S. Pat. No. 4,244,443 issued to Hiromitsu Naka on Jan. 13, 1981 entitled “Drawer Type Emergency Escape;” U.S. Pat. No. 4,919,235 issued to Eugene DelSalvio on Apr. 24, 1990 entitled “Fire Exit System;” U.S. Pat. No. 5,020,633 issued to Louis R. Rangel on Jun. 4, 1991 entitled “Emergency Escape Device;” U.S. Pat. No. 5,103,934 issued to Van L. Brooks on Apr. 14, 1992 entitled “Method and Apparatus for Providing a Fire Escape for a Multi-Story Building;” U.S. Pat. No. 5,303,799 issued to Hsin-Tan Tsai on Apr. 19, 1994 entitled “Emergency Escape Device;” U.S. Pat. No. 5,467,841 issued to Frank K. Knirmal on Nov. 21, 1995 entitled “Escape Window Frame Assembly;” U.S. Pat. No. 6,102,155 issued to Joshua H. Hood et al. on Aug. 15, 2000 entitled “Combined Window and Emergency Escape Ladder;” and U.S. Pat. No. 6,771,181 issued to Otis L. Hughen on Aug. 3, 2004 entitled “Crawl To the Light Emergency Exit.” Although these devices may aid a person in an emergency egress situation, they have a common requirement that they require the user to use his or her hands to use these devices. Consequently, it is difficult if not impossible to use these devices and carry a child or pet in the user's arms at the same time.

Another method of aiding emergency egress is providing rope descending systems that are deployed from a bar that swings away from the building from which egress is desired. Such systems are disclosed in U.S. Pat. No. 3,760,902 issued to Pierce Charles Hynes on Sep. 25, 1973 entitled “Lifesavings Systems For Escaping From High Buildings In The Case of Fires Or Other Emergencies;” U.S. Pat. No. 3,844,377 issued to William Wilkins on Oct. 29, 1974 entitled “Vehicle for Evacuating Buildings;” U.S. Pat. No. 3,880,255 issued to James B. Huntley on Apr. 29, 1975 entitled “Emergency Fire Escape Mechanism;” U.S. Pat. No. 4,287,963 issued to Darrel W. Coxsey on Sep. 8, 1981 entitled “Safety Apparatus;” U.S. Pat. No. 4,440,261 issued to Mark J. Clark on Apr. 3, 1984 entitled “Portable High-Rise Excape Device;” U.S. Pat. No. 4,503,933 issued to Michael J. O'Neil on Mar. 12, 1985 entitled “Building Evacuation Device;” U.S. Pat. No. 4,520,900 issued to Orey C. Orgeron on Jun. 4, 1985 entitled “Fire Escape Apparatus For Use In High-Rise Building And The Like;” U.S. Pat. No. 4,653,609 issued to Millard J. Device on Mar. 31, 1987 entitled “Controlled Descent Apparatus;” U.S. Pat. No. 4,671,384 issued to Peter Sing on Jun. 9, 1987 entitled “Window Escape Descent Control Device;” U.S. Pat. No. 4,703,831 issued to William E. Forrest et al. on Nov. 3, 1987 entitled “Fire Escape Apparatus For Use in Multi-Story Buildings and Method of Escape;” U.S. Pat. No. 5,064,021 issued to Ronald F. Bauer on Nov. 12, 1991 entitled “Window Escape;” U.S. Pat. No. 6,550,580 issued to Wellington S. Roches on Apr. 23, 2003 entitled “Fire Escape System;” U.S. Pat. No. 6,626,265 issued to Millard J. Devine on Sep. 30, 2003 entitled “Controlled Descent Apparatus;” U.S. Pat. No. 6,868,942 issued to Yoaz Barzilai on Mar. 22, 2005 entitled “Emergency Escape System;” and U.S. Pat. No. 6,966,407 issued to Loren Eugene Karnes et al. on Nov. 22, 2005 entitled “Escape-Right.” Once again, while these device may aid a person in an emergency egress situation, they also have a common requirement that they require the user to use his or her hands to use these devices. Consequently, it is difficult if not impossible to use these devices and carry a child or pet in the user's arms at the same time.

More sophisticated methods of providing emergency egress include tube-like devices into which the user jumps at a high point and which deposit the user at the ground (e.g., U.S. Pat. No. 5,871,066 issued to Norman Lee Reece on Feb. 16, 1999 entitled “Rescue Device”). A further type of emergency egress system employs a net to catch the user. Such a device is disclosed in U.S. Pat. Nos. 4,127,185 issued to Henry Ritter, Jr. on Nov. 28, 1978 entitled “Fire Escape Net.” In either of these devices, because of the contact between the user's arms and the walls of the tube or the need to balance one's self while falling, it would be difficult if not impossible to be able to securely hold a child or pet while using this device.

Another method of providing emergency egress is disclosed in U.S. Pat. No. 5,135,076 issued to Ching Y. Su on Aug. 4, 1992 entitled “Escape Slideway.” This device is a slide upon which the user may place themselves and move from the position of danger to the position of safety. Again, because of the need to gain access to and correctly position the user in such a device, it would be difficult or impossible to hold a child or pet while using this device.

There is also considerable concern regarding the safe emergency egress from transportation vehicles such as airplanes, ships or trains in the event of an emergency. The issues and concerns discussed above in connection with emergency egress from buildings apply as well to emergency egress from these transportation vehicles.

Although these devices make it easier to make an emergency egress, whether from a building or a transportation vehicle, it is often necessary under such circumstances to make an emergency egress with one's child or pet. This is typically done by holding the child or pet in one's arms. But, as has been briefly explained above, since most of the emergency egress devices require the use of the user's arms, it is difficult to effectively make use of such emergency egress systems while at the same time holding on to and caring for the user's child or pet. Further, even those emergency egress systems that do not require the user's arms, such as the emergency tube, net or slide, often make it difficult for the user to safely and effectively hold on to their child or pet. Consequently, it is highly desirable to provide a device that allows the user's child or pet to be securely attached to the body of the user and also allow the user the free use of their arms. Further, such a device would allow the user to not only make an emergency egress with her child or pad, but would also allow the user to assist others, including those with disabilities, to also make an emergency egress. In view of the foregoing, it can be seen that there is a need for a device that overcomes the problems and limitations set out above.

### SUMMARY OF THE INVENTION

The present invention is a device to be used during an emergency egress situation to enable a user to safely and effectively carry a child or pet during the emergency egress while at the same time allowing the user the full use of his or her arms during the egress. The device includes a pouch that is secured to the user's chest by means of straps that pass from the pouch over the user's shoulders, around the user's back and which are then secured to the pouch. The straps are easily adjustable to allow the invention to be put on the user and then rapidly secured to the user. The pouch is dimensioned to receive and securely hold a child or pet. The pouch also includes straps or a closure top that secures the child or pet within the pouch.

There are many objects of the present invention in its various embodiments that may be addressed individually or in combinations and permutations. Each embodiment may address one or several of the following objectives.

An object of this invention in one embodiment or variant of the invention is to enable the user to easily take their child or pet with them during an emergency egress situation.

Another object of the present invention in one embodiment or variant of the invention is to allow the user the free use of their hands while carrying a child or pet during an emergency egress situation.

Yet another object of the present invention in one embodiment or variant of the invention is to enable the user to more easily assist others, including disabled persons, while carrying a child or pet during an emergency egress situation.

A further object of the present invention in one embodiment or variant of the invention is to provide a device for carrying a child or pet during an emergency egress situation that is easy to put on and secure.

A further object of the present invention in one embodiment or variant of the invention is to provide a device for carrying a child or pet during an emergency egress situation that is compact and easy to store.

These and other objects and advantages of the invention will be clear in view of the following description to the invention including the associated drawings.

### BRIEF DESCRIPTION OF THE DRAWINGS

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. All Figures are drawn for ease of explanation of the basic teachings of the present invention only; the extensions of the Figures with respect to number, position, relationship, and dimensions of the parts to form the preferred embodiment will be explained or will be within the skill of the art after the following description has been read and understood. Further, the exact dimensions and dimensional proportions to conform to specific force, weight, strength and similar requirements will likewise be within the skill of the art after the following description has been read and understood.

FIG. 1 is a perspective view of one embodiment of the invention in use.

FIG. 2 is a front view of an embodiment of the invention in use.

FIG. 3 is a side view of an embodiment of the invention in use.

FIG. 4 is a top view of an embodiment of the invention in position on a user.

FIG. 5 is a back view of an embodiment of the invention in position on a user.

FIG. 6 is a front perspective view of an embodiment of the invention in position on a user.

FIG. 7 is an elevated side perspective view of an embodiment of the invention in position on a user.

FIG. 8 is a side view of an embodiment of the invention in use carrying a pet.

FIG. 9 is a side phantom view of an embodiment of the invention.

FIG. 10 is a perspective view of the present invention in a rolled up compact configuration.

FIG. 11 is a perspective view of another embodiment of the invention.

FIG. 12 is a front view of the instructions attached to the pouch in another embodiment of the invention.

### DETAILED DESCRIPTION OF THE INVENTION

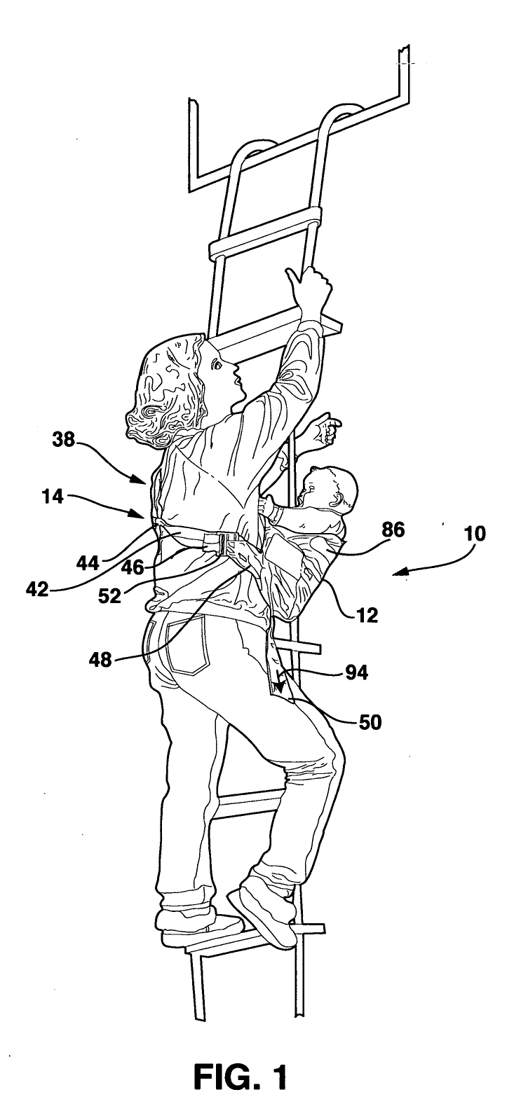

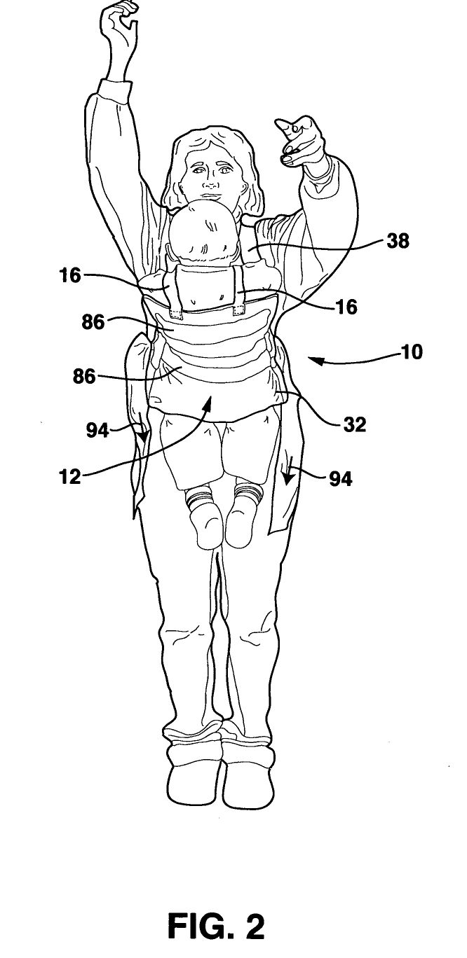

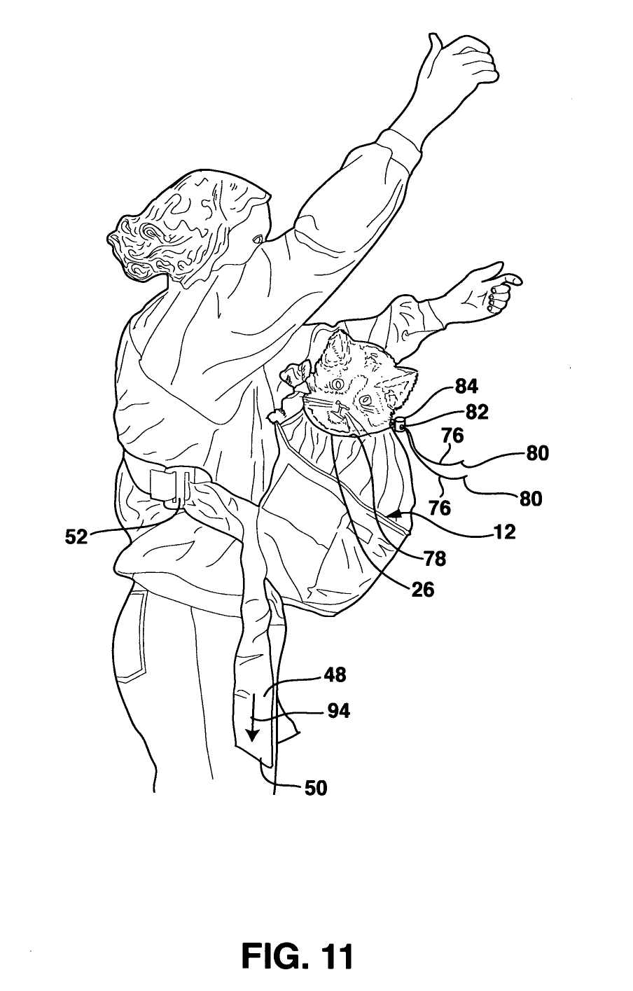

The emergency egress child or pet carrier of the present invention is shown in FIGS. 1-11 generally labeled 10. The emergency egress carrier 10 has a pouch 12 and securing straps 14. In a preferred embodiment, the emergency egress carrier 10 also has pouch contents securing straps 16 (FIGS. 2, 4, 6 and 7).

Pouch 12 is generally bowl shaped with a peripheral wall 18 and a bottom 20. The function of pouch 12 is to securely hold and position a child or pet the against the user's chest during an emergency egress. Peripheral wall 18 has an inside surface 22 that extends around the inside of pouch 12 and an outside surface 24 that extends around the outside of pouch 12. Peripheral wall 18 also has an upper edge 26 that defines the upper extremity of the pouch 12 and a lower edge 28 that is connected to the bottom 20. Further peripheral wall 18 has a chest facing side 30 and an outside facing side 32.

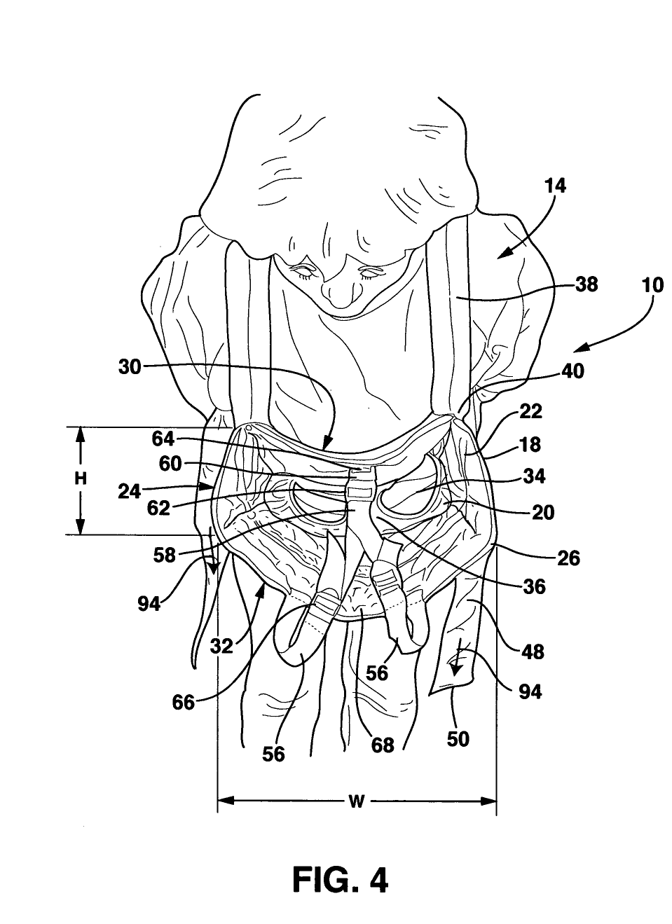

Bottom 20 is generally elongated so that pouch 12 is generally longer in the direction across the user's chest (“W”) than it is in the direction away from the user's chest (“H”). Peripheral wall 18 is preferably about 9 inches high and about 35 inches around the circumference of the upper edge 26.

Where the emergency egress carrier 10 is intended to be used to transfer a child, bottom 20 has a pair of leg holes 34 separated by a crotch piece 36 (FIG. 4). Leg holes 34 are sized to allow a child's feet and legs to pass through them. For example, leg holes 34 are preferably about 3½ inches in diameter. Further, crotch piece 36 separates the nearest edges of leg holes 34 from each other by about 1¾ inches.

The dimensions given for pouch 12, including the dimensions of leg holes 34 and crotch piece 36, are intended to be representative of the dimensions needed to provide a pouch 12 to hold an average sized child during an emergency egress operation. It is clear that pouch 12 may be made that larger or smaller than the exemplary dimensions given. It is also clear that the dimensions of pouch 12 may be adjusted in order to accommodate pets of varying sizes. For example, where the emergency egress carrier 10 is used to transport a small animal such as a Pekinese dog, the height and circumference of peripheral wall 18 would ideally be smaller than the dimensions given. Conversely, where the emergency egress carrier 10 is used to transport a larger animal such as a large cat, the height and circumference of peripheral wall 18 would ideally be larger than the dimensions given. As a result, it may be desirable provided emergency egress carrier 10 in a variety of sizes.

As mentioned above, emergency egress carrier 10 also has securing straps 14. The function of securing straps 14 is to secure the pouch 12, with its contents, securely to the user. Securing straps 14 preferably include a pair of shoulder straps 38 having a pouch attachment end 40 and an adjustment end 42. In the preferred embodiment, the pouch attachment end 40 of each shoulder strap 38 is securely attached to the chest facing side 30 of the outside surface 24 by sewing, adhesives, or by making securing straps 14 of the same contiguous material of pouch 12 to name but a few examples of how to attach securing straps 14 to pouch 12 that will readily occur to those skilled in the art. Although the pouch attachment end 40 of each shoulder strap 38 is securely attached to the chest facing side 30 of the outside surface 24 of the pouch 12, it is clear that the pouch attachment end 40 may be attached at any location to the pouch 12.

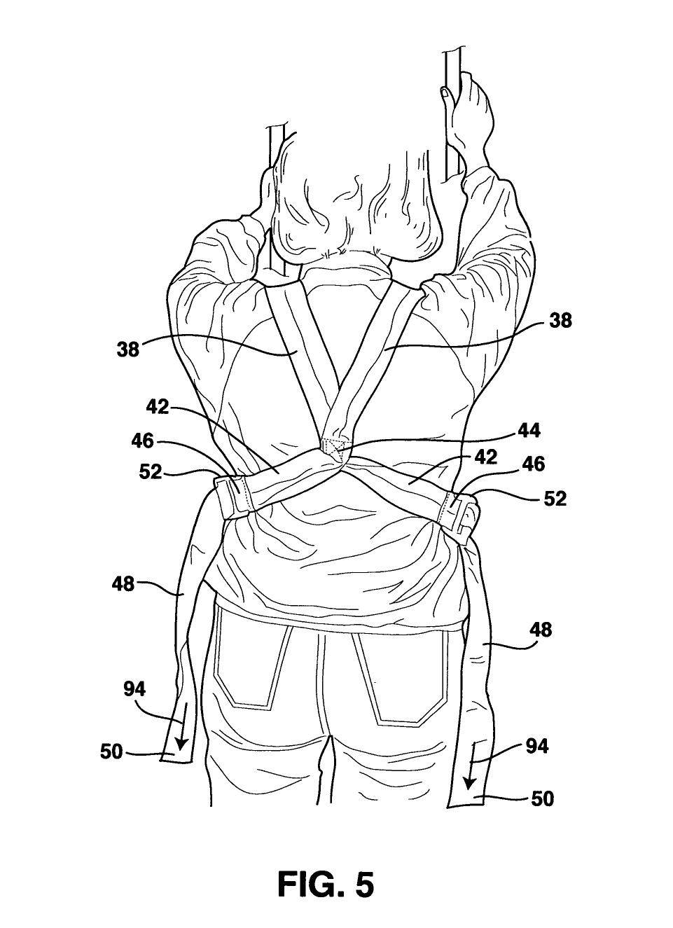

Each shoulder strap 38 is then securely fastened to the other shoulder strap 38 at a back secure point 44 (FIG. 5). The function of back secure point 44 is to secure one shoulder strap 38 to the other shoulder strap 38 and cause each shoulder strap 38 to change direction from a direction coming from the chest and over the user's shoulder to a direction going around the waist of the user.

Back secure point 44 is preferably accomplished by sewing one shoulder strap 38 to the other shoulder strap 38 at the back secure point 44. While the preferred method of forming back secure point 44 is the sewing process described, it is clear that other means for securing one shoulder strap 38 to the other shoulder strap 38 could also be used including but not limited to using a hook and loop fastener, grommet and swivel pin and buckle.

As mentioned above, each shoulder strap 38 changes direction at back secure point 44 to go around the user's waist. Each shoulder strap 38 has an adjustment end 42 that terminates in a terminal end 46.

Each securing strap 14 also includes a cinch strap 48 that is preferably attached to the outside surface 24 of the pouch 12 near the lower edge 28 of the chest facing side 30 of pouch 12 and has a terminal end 50. Each cinch strap 48 has a cinch strap terminal end 50 that is the end of cinch strap 48 not connected to the pouch 12. Although the cinch strap 48 is securely attached to the chest facing side 30 of the outside surface 24 of the pouch 12, it is clear that the cinch strap 48 may be attached at any location to the pouch 12.

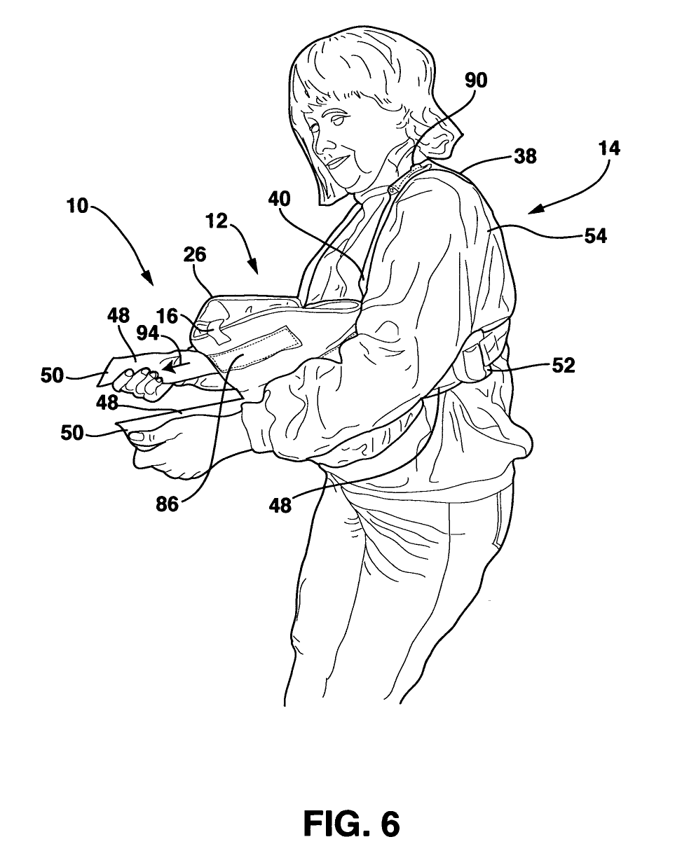

In the preferred embodiment shown in FIGS. 1, 3, 5, 6 and 7, each shoulder strap terminal end 46 has a cinch clasp 52 (FIG. 6). The function of the cinch clasp 52 is to allow a strap (e.g., the adjustment end 42 of the shoulder strap 38 or terminal end 50 of the cinch strap 48) to pass through the cinch clasp 52 and be secured against longitudinal movement of the strap through the cinch clasp 52. The cinch clasp 52 is preferably of the type commonly used to allow adjustment of the length of the shoulder straps on backpacks or similar devices while at the same time preventing such backpack shoulder straps from changing their longitudinal dimensions once tension is applied to the backpack shoulder straps.

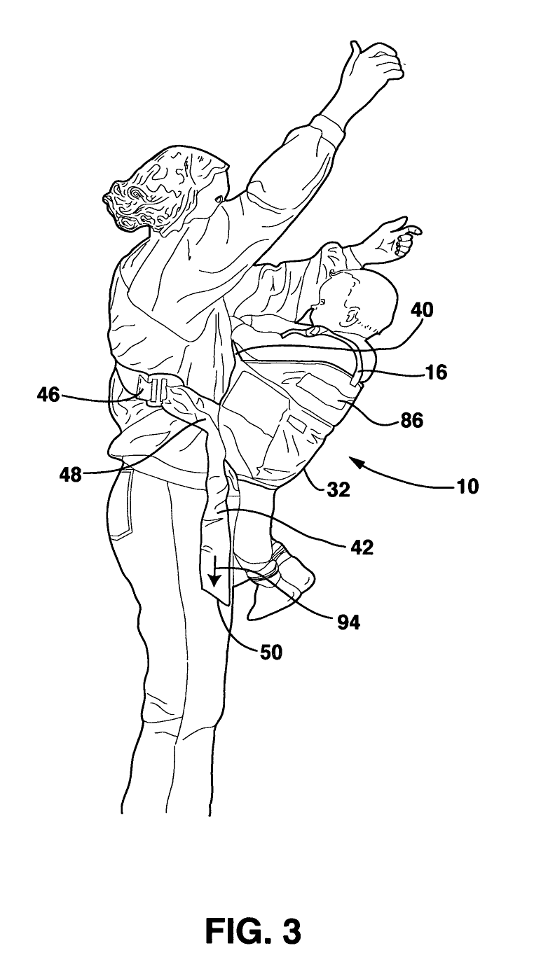

The cinch strap terminal end 50 of each cinch strap 48 is passed through the cinch clasp 52 and is presented so that the cinch strap terminal end 50 of each cinch strap 48 may be pulled through the cinch clasp 52 thereby cinching the chest facing side 30 of the pouch 12 into secure contact with the user's chest (FIGS. 1 and 3).

This arrangement forms a loop 54 for each shoulder strap 38 that allows the shoulder straps 38 to be positioned loosely initially so that the user may easily place the emergency egress carrier 10 on their body. This is accomplished by the user placing their arms through the loops 54 formed by the shoulder straps 38 as they move from their connection to the chest facing side 30 of the pouch 12, to the back secure point 44, through the cinch clasp 52 and its subsequent attachment to the chest facing side 30 of pouch 12 near the bottom 20 of the pouch 12 through cinch strap 48. Once the emergency egress carrier 10 is loosely on the user's shoulders and around the user's torso, the terminal ends 50 of the cinch straps 48 are pulled thereby pulling the cinch straps 48 through the cinch clasp 52. As a result, the cinch straps 48 pull the pouch 12 into secure contact with the user's chest on the chest facing side 30 of the pouch 12.

As mentioned above, the preferred embodiment of the emergency egress carrier 10 has the cinch clasp 52 attached to the shoulder strap terminal end 46 of the adjustment end 42 of the shoulder strap 38. But, the cinch clasp 52 may also be located on the terminal end 50 of cinch strap 48 and the shoulder strap terminal end 46 of each shoulder strap 38 threaded through the cinch clasp 52. Other arrangements for creating an adjustable loop 54 comprised of the shoulder straps 38 and the cinch strap 48 will occur to those skilled in the art and are intended to be part of the invention.

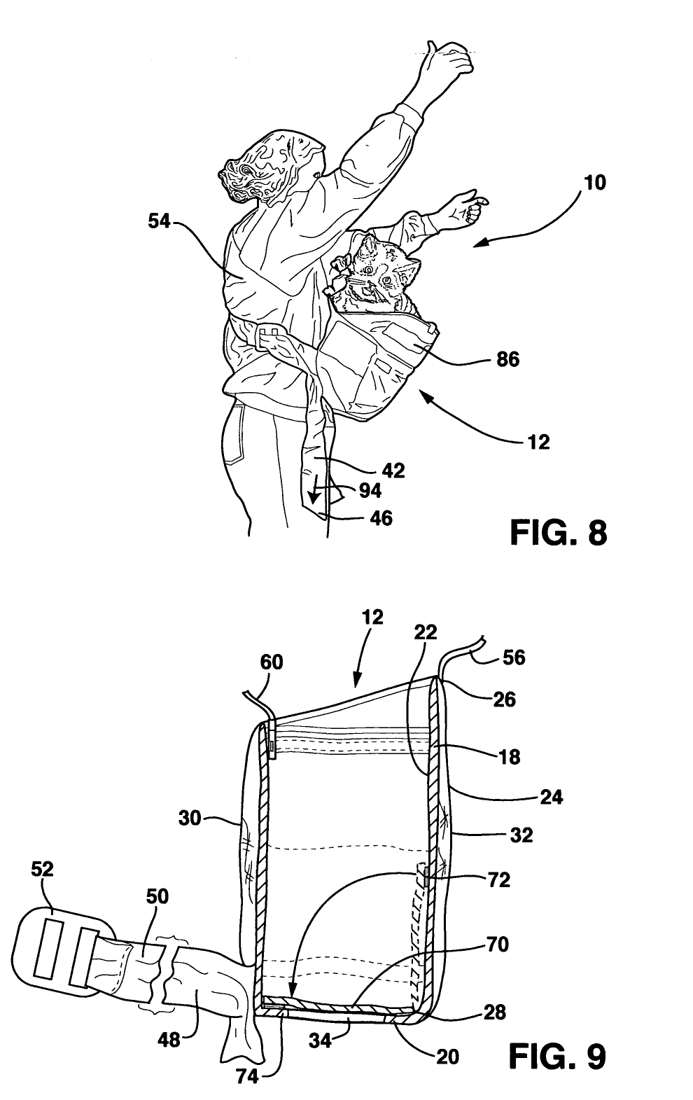

In this alternate embodiment of the invention shown in FIGS. 8 and 9, each securing strap 14 again also includes a cinch strap 48 that is attached to the outside surface 24 of the pouch 12 near the lower edge 28 of the chest facing side 30 of pouch 12 and has a terminal end 50. However, in this embodiment as mentioned above, each terminal end 50 of cinch strap 48 has a cinch clasp 52 (FIG. 9) as described above.

In this embodiment, the terminal end 46 of each shoulder strap 38 is passed through the cinch clasp 52 and is presented so that the terminal end 46 of each shoulder strap 38 may be pulled through the cinch clasp 52 thereby cinching the chest facing side 30 of the pouch 12 into secure contact with the user's chest (FIG. 8).

This arrangement also forms a loop 54 for each shoulder strap 38 that allows the shoulder straps 38 to be positioned loosely initially so that the user may easily place the emergency egress carrier 10 on their body. This is accomplished by the user placing their arms through the loops 54 formed by the shoulder straps 38 as they move from their connection to the chest facing side 30 of the pouch 12, to the back secure point 44, through the cinch clasp 52 and its subsequent attachment to the chest facing side 30 of pouch 12 near the bottom 20 of the pouch 12. Once the emergency egress carrier 10 is loosely on the user's shoulders and around the user's torso, the terminal ends 44 of the shoulder straps 38 are pulled thereby pulling the shoulder straps 38 through the cinch clasp 52. As a result, the shoulder straps 38 pull the pouch 12 into secure contact with the user's chest on the chest facing side 30 of the pouch 12.

In either of the embodiments above for the securing straps 14, it may be desirable to make either the shoulder strap terminal end 46 or the cinch strap terminal end 50 large enough so the respective terminal end can't pass through the cinch clasp 52. This may be accomplished in any way including but not limited to sewing the terminal end 46 back on itself, adding an element to the terminal end by sewing, encasement or adhesives or tying the terminal end 46 in a knot.

In the preferred embodiment, the emergency egress carrier 10 also includes pouch contents securing straps 16. In the preferred embodiment shown in FIG. 4, these pouch contents securing straps 16 take the form of a pair of securing straps 56 that come together at a securing strap secure point 58 and thereafter form a single strap 60. In the preferred embodiment, single strap 60 terminates in a releasable clasp 62 that is attached to the inside surface 22 of pouch 12 near the center of the chest of the user. Release clasp 62 is preferably of the type commonly used to bind and unbind straps to reach each other in environments such as camping and outdoor recreation. The function of releasable clasp 62 is to allow the single strap 60 to be easily and quickly separated from an attached to the inside surface 22 of pouch 12 at the attachment point 64 near the center of the chest of the user.

In addition, each of the securing straps 16 preferably passes through a length adjuster 66 so that their individual links can be rapidly adjusted. These length adjusters 74 are of the type commonly used to adjust the length of straps of, for example, backpack shoulder straps. The function of the length adjuster 66 is to allow the length of securing straps 16 to be adjusted to securely hold a child or pet in the pouch 12 as will be described hereafter. Between uses, it is highly desirable that the emergency egress carrier 10 be placed in a compact configuration for storage but also be ready to be immediately used in the event of an emergency situation. This is accomplished by adjusting the shoulder straps 38 and cinch straps 48 so that the loop 54 becomes the largest size possible thereby accommodating all users and allowing the emergency egress carrier 10 to be more readily donned in an emergency situation.

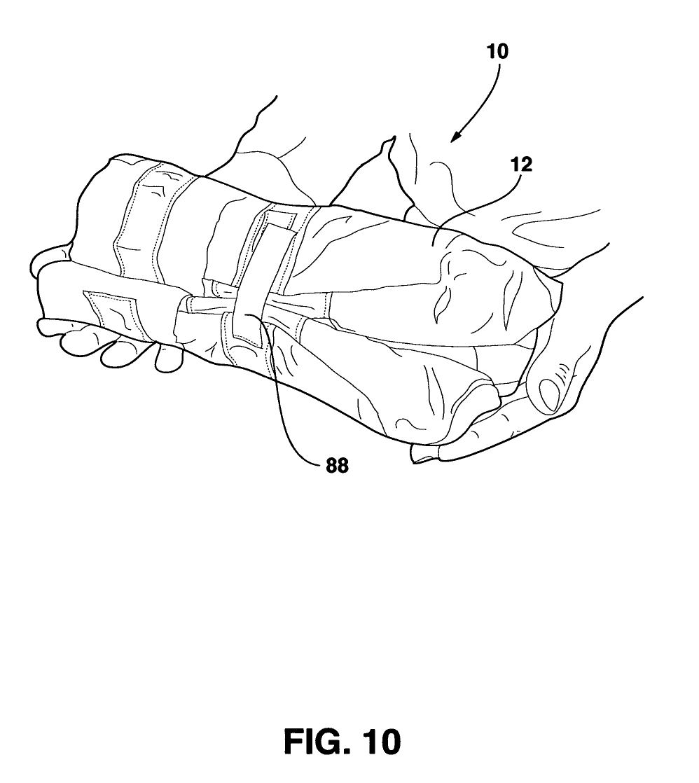

Thereafter, the pouch 12 is collapsed and securing straps 14 folded over or into the pouch 12 and the pouch 12 and securing straps 14 are rolled up to form a cylindrical configuration as shown in FIG. 10. A closure 88, preferably in the form of a hook and loop tab, secures the emergency egress carrier 10 in this rolled up and compact configuration. Although a hook and loop closure is the preferred way to hold the emergency egress carrier 10 in a rolled up configuration, other means for accomplishing this, including but not limited to straps, hooks, grommet and swivel pin and storing the emergency egress carrier 10 in a bag, as will occur to those skilled in the art are intended to be part of this invention. In this way, a plurality of emergency egress carrier 10 devices can be stored in a relatively small area and yet can be accessed and used as will be described hereafter. When a desirable to use the emergency egress carrier 10, the emergency egress carrier 10 is unrolled so that the pouch 12 is opened. Each of the shoulder straps 38 is positioned so that each loop 54 is made accessible to the user. Thereafter, the user places his or her arms through the loop 54 so that the pouch 12 is placed on the chest of the user with the chest facing side 30 of the pouch 12 in contact with the user's chest. The user then, depending on the embodiment of the securing straps 14, grasps either the terminal ends 50 of the cinch straps 48 or the terminal ends 46 of the shoulder straps 38 and pulls. In the embodiment having the cinch clasp 52 attached to the terminal end 46 of the shoulder strap 38, the user pulls in a direction away from the chest of the user. In the embodiment having the cinch clasp 52 attached to the terminal end 50 of the cinch strap 48, the user pulls in a direction toward the back of the user. In this way, each of the cinch straps 48 or shoulder straps 38, respectively, are pulled through a respective cinch clasp 52 thereby making the loop 54 smaller and at the same time pulling the pouch 12 into secure contact with the user's chest.

Once the pouch 12 is moved into secure contact with the user's chest, a child or pet may be placed in the pouch 12. Releasable clasp 62 is released and the securing straps 16 are moved over the upper edge 26 on the outside facing side 32 of the pouch 12 so that the securing straps 16 are on the outside surface 24 of the pouch 12. If a child is placed in the pouch 12, the child is turned so that the child is facing the chest of user. The child's legs are placed through the leg holes 34 so that the child's crotch comes into contact with the crotch piece 36. In this way, the bottom 20 supports the weight of the child while the peripheral wall 18 constrains the child in close contact with the chest of the user.

The securing straps 16 are placed over the child's shoulders so that the child's head is in the loop 68 formed between the securing straps 16. The single strap 60 is moved so that the releasable clasp 62 may be secured to the inside surface 22 of the pouch 12 at attachment point 64. Thereafter, the cinch strap terminal ends 50 of the pouch contents securing straps 16 are pulled through the length adjusters 66 so that the securing straps 16 are brought into snug contact with the shoulders of the child placed in the pouch 12. In this way, the child is securely held in the pouch 12 which pouch 12 is securely attached to the user' body at the chest of the user.

In an embodiment of the emergency egress carrier 10 used to transport a pet during an emergency egress situation, it is preferable that the pet's legs not fall through the leg openings 22 described above. Consequently, in one embodiment of the emergency egress carrier 10, the leg openings 22 are removed so that the bottom 20 is a single contiguous piece. In another embodiment of the emergency egress carrier 10, a flap 70 may be placed in the pouch 12 and secured to the pouch where the lower edge 28 of the peripheral wall 18 attaches to the bottom 20 by means such as sewing, adhesives or other means that will occur to those skilled in the art. Flap 70 is preferably made of sturdy material to prevent a pet's feet from deforming the flap 70 or moving the flap 70 aside so that the pet's feet would pass through the leg holes 34. Flap 70 preferably has a connector 72 such as a hook and loop faster that allows the flap 70 to be securely attached to the inside surface 22 of pouch 12 when not in use so as not to inadvertently interfere with the use of the emergency egress carrier 10 when it is needed to be used to transport a child.

In this embodiment, if it becomes necessary to transport a pet in an emergency egress situation, flap 70 is separated from the inside surface 22 of pouch 12 by releasing the connector 72 and allowing the flap 70 to come into contact with the bottom 20. It may be desirable to have a corresponding connector 74, similar to connector 72, in the bottom 20 so as to securely of the flap 70 in place on the bottom 20.

In a variant of this embodiment, the flap 70 may not be attached to either the peripheral wall 18 or bottom 20. Instead, the flap 70 may be a separate piece within the pouch 12 that covers the leg holes 34 in the embodiment of the emergency egress carrier 10 having leg holes 34.

To use the emergency egress carrier 10 in this embodiment, once again the releasable clasp 62 is released and the securing straps 16 are placed over the upper edge 26 of the peripheral wall 18 on the outside facing side 32 of the pouch 12. The pet is then placed in the pouch 12 in the securing straps 16 placed over the pet at the top of the pouch 12. The releasable clasp 62 is then reattached to its attachment point 64 on the inside surface 22 of the pouch 12. In this way, the pet is secured within the pouch 12 which pouch 12 is secured to the user as described above.

Although the preferred embodiment of the emergency egress carrier 10 has securing straps 16, a variant of the invention does not have securing straps 16. Instead, the upper edge 26 of the peripheral wall 18 may have a cinch cord 76 within a chamber 78 found at the upper edge 26 of preferred wall 18 such as is commonly found on the hoods of sweatshirts. Cinch cord 76 has a pair of terminal ends 80. The chamber 78 may be formed by taking the material of the upper edge 26 of peripheral wall 18 and stitching it back on itself so that it chamber 78 is formed around the entire upper edge 26 of peripheral wall 18.

A small hole 82 is formed in chamber 78, preferably on the front facing side 30 of the pouch 12. Cinch cord 76 is placed in chamber 78. The cinch cord 76 is placed in the chamber 78 so that the terminal ends 80 of cinch cord 76 pass out of hole 82. In this embodiment, it is desirable to place a cord retainer 84 on the cinch cord 76 outside of the hole 82. The function of the cord retainer 84 is to secure the two terminal ends 80 of the cord together in a non-slipping way at the cord retainer 84. In practical effect, when the cinch cord 76 is pulled through the hole 82 and the cord retainer moved down the cinch cords 88 next to the hole 82, the chinch cord 88 is prevented from moving further out of the hole 82 and the chamber 78 is pulled down or snugged down around the opening formed by the contracted chamber 78 along the upper edge 26 of pouch 12.

In use with this embodiment, emergency egress carrier 10 is placed on the user's body as described above. However when it desired to place the child or pet in the pouch 12 the cord retainer 84 is released so that the cinch cord 76 may be allowed to expand the upper surface 92 of peripheral wall 18 to its maximum extent. The child or pet is then placed in the pouch 12 as described above. The cinch cord 76 is then pulled towards the hole 82 so that the upper edge 26 of pouch 12 is contracted and secured around the neck and shoulders of the child or pet by the opening formed by the contraction of the chamber 78. The cord retainer 84 is then moved along be cinch cord 76 towards the hole 82 thereby securing the child or pet within the pouch 12.

Because of the demanding environment in which the emergency egress carrier 10 would typically be used, it is important that the components of the emergency egress carrier 10 be durable and strong. Pouch 12 is preferably made of a rugged and durable material such as nylon, polyester or denim although it could be made of any rugged and durable material including but not limited to nylon, polyester or denim. In a preferred embodiment, pouch 12 is made of a highly visible color such as neon yellow, orange or red and may also include one or more reflective strips 86 or the entire pouch may be made of a material that is reflective. In this way, pouch 12 will help to make the user more visible to emergency personnel during the emergency egress. Further, it may be desirable to make the emergency egress carrier 10 of a material that is resistant to heat or fire. In addition, is important that all the straps, such as securing straps 14 and pouch contents securing straps 16, and cinch cord 76 as well as their associated securing hardware such as cinch clasp 52, releasable clasp 62, length adjuster 66 and cord retainer 84 also be made of rugged and durable materials such as plastics such as polycarbonates, nylon, ABS or metals such as stainless steel or brass in order for these pieces to be strong enough to secure the pouch 12 in contact with the user and the child or pet within pouch 12 in a secure manner.

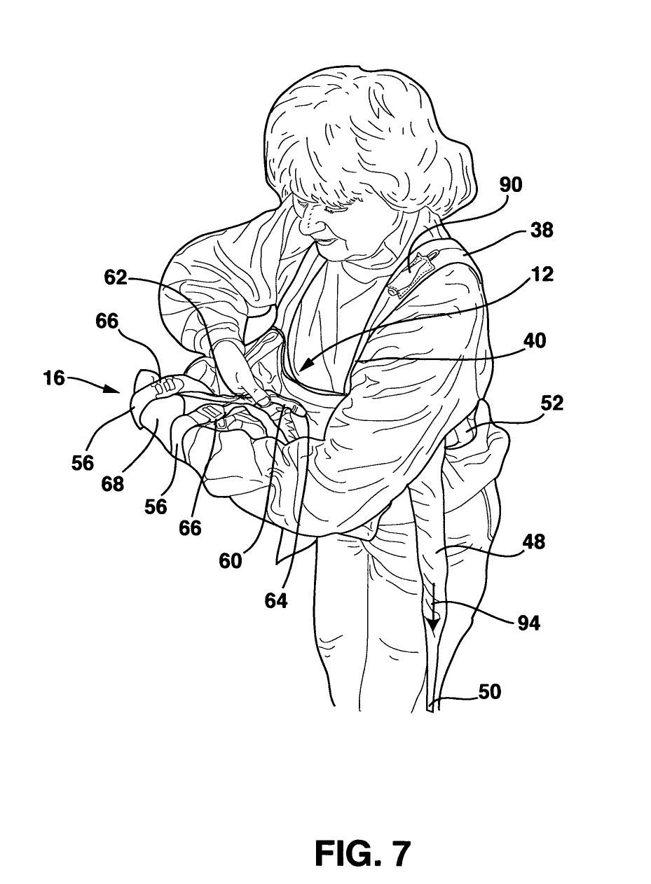

Further, it may be desirable to attach a light 90 to the emergency egress carrier 10 in order to aid the user in the egress. Such a light 90 may be attached to the shoulder straps 38 (FIGS. 6 and 7), pouch 12 or may be attached to any other part of the emergency egress carrier 10 as will occur to those skilled in the art so long as the light 90 is in a position to be accessible and most preferably positioned and attached to the emergency egress carrier in order to be able to shine to illuminate the way before the user (FIGS. 6 and 7). In addition, other implements useful in an emergency egress situation may be attached to the emergency egress carrier 10 in addition to or in combination with the light 90. Examples of implements useful in an emergency egress include, but are not limited to, a whistle, cell phone, radio, pocket knife, pliers, hammer to break glass, eye protection and breathing assisting or filtering device.

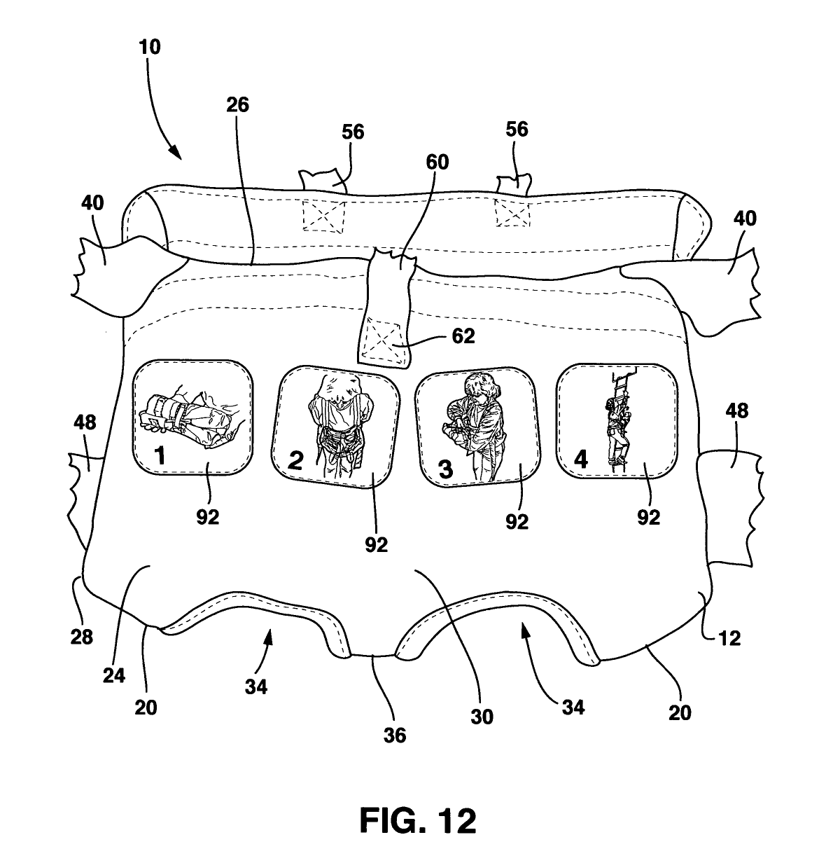

Further, as shown in FIG. 12, it may be desirable to add instructions 92 on how to deploy and use the emergency egress carrier 10. In the embodiment shown in FIG. 12, the instructions 92 are a sequence of pictures showing the deployment and use of the emergency egress carrier 10. These instructions 92 are preferably located on the emergency egress carrier 10 where they are readily observable such as on the chest facing side 30 of the pouch 12 (FIG. 12) although they may be placed elsewhere on the pouch 12 or attached to the shoulder straps 38 to name but two other examples of locations for the instructions. It is also clear that instructions 92 may also contain script as well as pictures or diagrams.

In addition, it may be desirable to color-code certain components of the emergency egress carrier 10 in order to aid the user in deploying and using the invention. For example, it is considered unlikely that the terminal ends of the cinch strap terminal end 50 or the shoulder strap terminal end 46 should become unthreaded from the cinch clasp 52 in their respective embodiments. But, it may be desirable to make each cinch clasp 52 and its respective terminal end of the cinch strap terminal end 50 or the shoulder strap terminal end 46 of material of the same color to aid the user in reconnecting the respective components should they become disconnected.

Further, in the preferred embodiment of the emergency egress carrier 10 it is desirable to aid the user of the emergency egress carrier 10 in the steps necessary to don the emergency egress carrier 10 and secure the pouch 12 to the chest of the user as described above. This is particularly useful because the emergency egress carrier 10 is used, by definition, primarily to aid the user's egress in an emergency situation where there is likely to be confusion, fear and a sense of urgency, all of which may negatively affect the user's ability to quickly and successfully don and use the emergency egress carrier 10. In one embodiment of the emergency egress carrier 10, arrows 94 have been printed, formed or sewn on or otherwise attached near the terminal ends of the shoulder strap terminal end 46 or cinch strap terminal end 50, depending on the embodiment of the securing straps 14 described above so that the arrow 94 shows the user the direction to pull the respective shoulder strap terminal end 46 or cinch strap terminal end 50 to pull the pouch into secure contact with the user's chest.

The invention described above is primarily intended and is useful for use in buildings particularly buildings exceeding one story. However, the present invention is not required to be exclusive to buildings. Modes of transportation such as airplanes, trains and ships can also benefit by the use of this invention. In addition, the present invention may also find application in homes to allow the user to safely, rapidly and easily make an emergency egress from their home with their child or pet.

The present invention has been described in connection with certain embodiments, configurations and relative dimensions. However, description above is not to be construed as being absolutely particular. It is to be understood that the description given herein has been given for the purpose of explaining and illustrating the invention and are not intended to limit the scope of the invention. For example, additional methods of attaching the shoulder straps 38 to the pouch 12 or the flap 70 to the pouch 12 may be used as will be clear to those skilled in the art. Further, additional means for securing the flap 70 to the peripheral wall 18 or bottom 20 will occur to those skilled in the art. Also, there are many materials and configurations that can be used in constructing the invention by those skilled in the art including those being developed or that will be developed. In addition, it is clear than an almost infinite number of minor variations to the form and function of the disclosed invention could be made and also still be within the scope of the invention. Consequently, it is not intended that the invention be limited to the specific embodiments and variants of the invention disclosed. It is to be further understood that changes and modifications to the descriptions given herein will occur to those skilled in the art. Therefore, the scope of the invention should be limited only by the scope of the claims.

I claim:

1. An emergency egress carrier for aiding a user in making an emergency egress with a child or pet comprising:
a generally bowl shaped pouch, the pouch having a bottom and an inside surface that extends around the inside of pouch and an outside surface that extends around the outside of the pouch, the pouch also having an upper edge that defines the upper extremity of the pouch and a chest facing side; and
securing straps for holding the pouch in secure contact with the chest of the user.

2. The emergency egress carrier of claim 1 wherein the bottom is generally elongated so that pouch is generally longer in the direction across the user's chest than it is in the direction away from the user's chest.

3. The emergency egress carrier of claim 1 wherein the bottom has a pair of leg holes separated by a crotch piece and wherein the leg holes are sized to allow a child's feet and legs to pass through them.

4. The emergency egress carrier of claim 3 wherein the emergency egress carrier further comprises a flap made of a sturdy and durable material that is placed in the pouch to cover the leg holes.

5. The emergency egress carrier of claim 4 wherein the flap is permanently attached to the pouch.

6. The emergency egress carrier of claim 4 wherein the flap is not permanently attached to the pouch.

7. The emergency egress carrier of claim 1 wherein the securing straps include a pair of shoulder straps having a pouch attachment end, an adjustment end and a terminal end and wherein the pouch attachment end of each shoulder strap is securely attached to the pouch.

8. The emergency egress carrier of claim 7 wherein each shoulder strap is securely fastened to the other shoulder strap at a back secure point whereby one shoulder strap is secured to the other shoulder strap and whereby each shoulder strap changes direction from a direction coming from the chest and over a user's shoulder to a direction going around the waist of the user.

9. The emergency egress carrier of claim 7 wherein each securing strap also includes a cinch strap that is attached to the pouch and wherein the cinch strap has a terminal end and wherein the terminal end of each shoulder strap has a cinch clasp and wherein the terminal end of each cinch strap is passed through a respective cinch clasp thereby forming a loop created by each shoulder strap so that the terminal end of each cinch strap may be pulled through the cinch clasp thereby cinching the chest facing side of the pouch into secure contact with a user's chest.

10. The emergency egress carrier of claim 9 wherein at least the terminal end of each cinch strap and its corresponding cinch clasp are made of material of the same color.

11. The emergency egress carrier of claim 7 wherein each securing strap also includes a cinch strap that is attached to the pouch and wherein the cinch strap has a terminal end and wherein the terminal end of the cinch strap has a cinch clasp and wherein the terminal end of each shoulder strap is passed through a respective cinch clasp thereby forming a loop created by each shoulder strap so that the terminal end of each shoulder strap may be pulled through the cinch clasp thereby cinching the chest facing side of the pouch into secure contact with a user's chest.

12. The emergency egress carrier of claim 11 wherein at least the terminal end of each shoulder strap and its corresponding cinch clasp are made of material of the same color.

13. The emergency egress carrier of claim 1 wherein the securing straps include a pair of shoulder straps each having a terminal end and a pair of cinch straps each having a terminal end and wherein at least the terminal ends of the shoulder straps or the terminal ends of the cinch straps have an arrow to indicate to the user the direction to pull the respective terminal ends of the shoulder straps or the terminal ends of the cinch straps to secure the pouch to the user's chest.

14. The emergency egress carrier of claim 1 further comprising pouch contents securing straps for constraining the contents of the pouch within the pouch.

15. The emergency egress carrier of claim 14 further wherein the pouch contents securing straps comprise a pair of securing straps that come together at a securing strap secure point and thereafter form a single strap.

16. The emergency egress carrier of claim 15 further comprising a releasable clasp that is attached to the inside surface of pouch near the center of the chest of the user and to the single strap.

17. The emergency egress carrier of claim 14 further comprising a length adjuster and wherein each of the securing straps passes through a length adjuster so that their individual links can be rapidly adjusted.

18. The emergency egress carrier of claim 1 wherein the upper edge of the pouch includes a chamber having a hole and a cinch cord having terminal ends, the cinch cord located in part within the chamber so that at least the terminal ends of the cinch cord pass out of the hole and further comprising cord retainer having both terminal ends of the cinch cord passing through it, the cord retainer located outside the chamber.

19. The emergency egress carrier of claim 1 wherein the emergency egress carrier is collapsed and rolled up to form a compact, cylindrical configuration.

20. The emergency egress carrier of claim 1 wherein the emergency egress carrier includes at least a portion that is reflective to light to make the user more visible to emergency personnel during the emergency egress.

21. The emergency egress carrier of claim 1 wherein the emergency egress carrier includes instructions on how to deploy and use the emergency egress carrier wherein the instructions are attached to the emergency egress carrier.

22. The emergency egress carrier of claim 1 wherein the emergency egress carrier includes implements to aid a user in an emergency egress wherein such implements are chosen from the group consisting of a light, a whistle, cell phone, radio, pocket knife, pliers, hammer to break glass, eye protection and breathing assisting or filtering device.

23. An emergency egress carrier for aiding a user in making an emergency egress with a child or pet comprising:
a generally bowl shaped pouch, the pouch having a bottom, the peripheral wall having an inside surface that extends around the inside of pouch and an outside surface that extends around the outside of pouch, the peripheral wall also having an upper edge that defines the upper extremity of the pouch and a lower edge that is connected to the bottom, the peripheral wall also having a chest facing side and an outside facing side, wherein the bottom is generally elongated so that pouch is generally longer in the direction across the user's chest than it is in the direction away from the user's chest; and
securing straps for holding the pouch in secure contact with the chest of a user wherein the securing straps include a pair of shoulder straps having a pouch attachment end, an adjustment end and a terminal end and wherein the pouch attachment end of each shoulder strap is securely attached to the chest facing side of the outside surface of the pouch, wherein each shoulder strap is securely fastened to the other shoulder strap at a back secure point whereby one shoulder strap is secured to the other shoulder strap and whereby each shoulder strap changes direction from a direction coming from the chest and over the user's shoulder to a direction going around the waist of the user and wherein each securing strap also includes a cinch strap that is attached to the outside surface of the pouch near the lower edge of the chest facing side of pouch and wherein the cinch strap has a terminal end and wherein the terminal end of the cinch strap has a cinch clasp and wherein the terminal end of each shoulder strap is passed through a respective cinch clasp thereby forming a loop for each shoulder strap so that the terminal end of each shoulder strap may be pulled through the cinch clasp thereby cinching the chest facing side of the pouch into secure contact with the user's chest.

24. The emergency egress carrier of claim 23 wherein the bottom has a pair of leg holes separated by a crotch piece and wherein the leg holes are sized to allow a child's feet and legs to pass through them.

25. The emergency egress carrier of claim 23 further comprising means for securing a child or pet within the pouch.

26. A method of aiding an emergency egress comprising the steps of:
(a) providing an emergency egress carrier comprising:
(1) a generally bowl shaped pouch, the pouch having a bottom and an inside surface that extends around the inside of pouch and an outside surface that extends around the outside of the pouch, the pouch also having an upper edge that defines the upper extremity of the pouch and a chest facing side, wherein the bottom is generally elongated so that pouch is generally longer in the direction across the user's chest than it is in the direction away from the user's chest; and
(2) securing straps for holding the pouch in secure contact with the chest of the user wherein the securing straps include a pair of shoulder straps having a pouch attachment end, an adjustment end and a terminal end and wherein the pouch attachment end of each shoulder strap is securely attached to the pouch, wherein each securing strap also includes a cinch strap that is attached to the pouch and wherein the cinch strap has a terminal end and wherein the securing straps have means for adjustably connecting the shoulder straps to the cinch straps thereby forming a loop for each shoulder strap and wherein the means for adjustably connecting the shoulder straps to the cinch straps pulls the chest facing side of the pouch into secure contact with a user's chest;
(b) placing the user's arms through the loops formed by the shoulder straps as they move from their connection to the pouch, through the cinch clasp and the cinch strap's subsequent attachment to the pouch;
(c) activating the means for adjustably connecting the shoulder straps to the cinch straps whereby the shoulder straps pull the pouch into secure contact with the user's chest on the chest facing side of the pouch; and
(d) placing a child or pet in the pouch.
